(19) United States
(12) Patent Application Publication
(10) Pub. No.: US 2012/0293369 A1
(43) Pub. Date: Nov. 22, 2012

(54) SYSTEM, METHOD AND COMPUTER PROGRAM FOR NAVIGATION DATA BIT SYNCHRONIZATION FOR A GNSS RECEIVER

(75) Inventors: Zhe Liu, Calgary (CA); Francis Yuen, Calgary (CA)

(73) Assignee: BASEBAND TECHNOLOGIES INC., Calgary, AB (CA)

(21) Appl. No.: 13/575,570

(22) PCT Filed: Jan. 27, 2011
(86) PCT No.: PCT/CA11/00086

§ 371 Date: Jul. 26, 2012

Related U.S. Application Data
(60) Provisional application No. 61/298,713, filed on Jan. 27, 2010.

(51) Int. Cl. G01S 19/37

(52) U.S. Cl. 342/357.77

(57) ABSTRACT

The present invention relates to navigation data bit synchronization for a GNSS receiver and more specifically to a software-based GNSS receiver that is operable to rapidly achieve accurate navigation data bit synchronization. It provides a system, method and computer program for navigation data bit synchronization for a GNSS receiver. The system comprises a navigation bit synchronization engine operable to detect one or more indicators in one or more data samples received from a GNSS satellite. The location of the navigation bit is derivable from the one or more indicators. The bit synchronization engine may include one or more of (i) a coarse search utility, (ii) a regular search utility, (iii) a fine search utility and (iv) a bit-edge prediction utility.

### CROSS-REFERENCE TO RELATED APPLICATIONS

This application claims the benefit of U.S. Provisional Application No. 61/298,713 filed Jan. 27, 2010, the entirety of which is incorporated herein by reference.

### FIELD OF THE INVENTION

The present invention relates to navigation data bit synchronization for a GNSS receiver. The present invention more specifically relates to a GNSS receiver that is operable to rapidly achieve accurate navigation data bit synchronization.

### BACKGROUND TO THE INVENTION

Global navigation satellite systems (GNSS) techniques are used for determining position/velocity/time (PVT) at a receiver. GNSS receivers acquire, process and decode space-based navigation signals to determine PVT. GNSS includes the Global Positioning System (GPS) of the United States, the GLONASS system of Russia, the GALILEO system of European Union, the BEIDOU/COMPASS system of China and any other similar satellite systems.

Traditional GPS receivers comprise a RF circuitry and a dedicated baseband processor to acquire, extract, down-convert and demodulate GPS spread spectrum signals for position/velocity/time (PVT) processing. Traditional GPS receivers normally determine positions by computing times of arrival of signals transmitted from not-less-than 4 GPS satellites. Each satellite transmits a navigation message that includes its own ephemeris data as well as satellite clock parameters.

Traditional GPS receivers acquire, track and decode GPS navigation message in real-time. The navigation message includes information such as almanac/ephemeris parameters, a highly accurate time tag, satellite clock corrections, atmospheric models/corrections as well as other information that is necessary for PVT determination by a receiver.

Meanwhile, software based GPS receivers have been developed as an evolutionary step in the development of modern GNSS receivers. Instead of using a dedicated baseband processor, software-based GNSS receiver technologies (also known as Software-Defined Radio or SDR) employ only the RF circuitry to extract, down-convert, demodulate and process the GPS signals using software on a general purpose processor such as a central processing unit (CPU) or digital signal processor (DSP). The idea is to position the processor as close to an antenna as is convenient, transfer received I/Q samples into a programmable element and apply digital signal processing techniques to compute the receiver position. Software based GNSS receivers are an attractive solution since they can be easily scaled to accept and utilize advances in GPS protocols. For example, in the near future some GNSS protocols will have a number of additional signals that can be utilized for positioning, navigation, and timing. Typically, software receivers only need a software upgrade to allow for the inclusion of the new signal processing, while users of hardware-based receivers will have to purchase new hardware components to access these new signals. Other benefits of software based GPS receivers include rapid development time, cost efficiency and notable flexibility.

In order for the traditional receiver to compute the receiver position, it requires real-time navigation message data. During acquisition, the receiver can identify satellites visible to the receiver. If a satellite is visible to the receiver, the receiver can determine its frequency and Code Phase. The Code Phase denotes the point in the current data block where the coarse acquisition (C/A) code begins. The C/A code is a pseudo-random sequence and repeats itself once every millisecond. This way the Code Phase can also be treated as the residual of the pseudorange measurement modulated by 1 ms, or the pseudorange measurements with an unknown integer of milliseconds bias.

The traditional software-based GPS receivers also require real-time navigation message data to obtain the accurate time tag to compute the receiver position. Similar to that of the traditional hardware-based GPS receivers, the architecture of the traditional software-based GPS receivers also hosts the tracking loops components, which typically include Delay Lock Loop (DLL) and Phase Lock Loop (PLL).

When the signal is properly tracked, the C/A code and the carrier wave are removed, leaving only the navigation message data bits. One GPS navigation message frame lasts for 30 seconds, hence, it will take no less than 30 seconds to obtain a complete GPS navigation message frame. It is necessary to perform navigation data bit synchronization to locate the navigation message.

The navigation data bit synchronization may only be performed after the tracking loops are locked. Depending on many factors, the navigation data bit synchronization may take up to one second, while the navigation data frame synchronization may take up to six seconds. Furthermore, the navigation data bit synchronization may not be possible when received signals are weak. In order to deal with weak GPS signal problems, traditional GNSS receivers may increase the length of coherent integration period at both acquisition and tracking. However, the presence of the navigation data bit transition limits the maximum coherent integration time to 20 ms which, in some cases, is insufficient for many applications. In order to increase the receiver sensitivity for applications such as indoor navigation, it is desirable to perform coherent integration over a time period that is longer than 20 ms.

The beginning of each C/A code period is known after acquisition, but the beginning of the navigation data bits, which are composed of 20 C/A code periods, is not known. As such, the navigation data bit synchronization of the traditional GPS receivers is subject to navigation data bit offset ambiguity. This ambiguity is due to a lack of knowledge in the beginning and ending of the navigation data bits. If the assumed navigation data bits do not accurately align with the actual navigation data bits, it may either fail the GPS positioning or introduce additional errors into the raw measurements and PVT results.

U.S. Pat. No. 6,934,322 to Motorola Inc. discloses a system and method for GNSS receivers to achieve navigation data bit synchronization. The synchronization method employs both coherent and non-coherent integration to detect the navigation data bit transition. However, non-coherent integration has a squaring loss over coherent integration. The method also uses the peak values of coherent and non-coherent integration to detect the navigation data bit transition. However, the system and method disclosed have low efficiency, high computation load and poor performance when dealing with noise and interference presented on the GPS signals.

There is a need, therefore, to provide an implementable GNSS receiver system that is operable to rapidly perform accurate navigation data bit synchronization without the need of tracking loops that have high efficiency and low computation load that enables software implementation with high performance.

### SUMMARY

The present disclosure relates to a system, method and computer program for navigation data bit synchronization for a GNSS receiver.

In an embodiment, there is provided a system for data bit synchronization for a GNSS receiver, the system consists of a navigation bit synchronization engine having access to a processor and memory and operable to detect one or more indicators with data samples received from a GNSS satellite. The location of the navigation bit is derivable from one or more indicators.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a system in accordance with an embodiment.

FIG. 2 illustrates two data sets S and S* acquired by the coarse search utility.

FIG. 3 illustrates the correlation peaks of a GPS signal of a 10 ms data set if the effect of noise is not considered.

FIG. 4 illustrates determination of the location of the navigation data bit transition.

### DETAILED DESCRIPTION

The present disclosure relates to a system, method and computer program for navigation data bit synchronization for a GNSS receiver. It enables a GNSS receiver to rapidly achieve accurate navigation data bit synchronization. The solution is implementable in software or hardware and without requiring the tracking loops which are usually essential for traditional GNSS receivers. A bit synchronization engine is provided to perform navigation data bit synchronization by processing I/Q samples collected by a typical RF circuitry. Due to simple hardware design and optimized techniques, the overall power consumption of the bit synchronization engine is extremely low or, in some cases, negligible and is therefore implementable to common commercially available GNSS receiver designs. In accordance with an embodiment, the navigation data bit synchronization technique helps increase coherent integration time and thus enabling many new applications.

The bit synchronization engine is operable to detect one or more indicators with data samples received from a GNSS satellite. The location of the navigation bit is derivable from one or more indicators. The bit synchronization engine may comprise a coarse search utility, regular search utility and fine search utility. The one or more indicators may be any of a correlation peak, code phase, acquisition margin, carrier to noise ratio, or other indicators. The bit synchronization engine may comprise a coarse search utility operable to obtain a plurality of overlapping data sample sets with predetermined length that have a navigation data bit transition within their overlapping zones. One of the data sample sets may be delayed relative to another of the data sample sets by a time less than the predetermined length. The bit synchronization engine may further comprise a regular search utility operable to compute an approximate bit transition location by a function based on the correlation peaks of the two overlapping data sample sets. The bit synchronization engine may further comprise a fine search utility operable to compute an accurate bit transition location by removing the code phase from the approximate bit transition location. The bit synchronization engine may further comprise a bit-edge prediction utility operable to predict the next navigation data bit edge which is also the beginning of the next navigation data bit, by skipping forward 20 ms from the accurate bit transition location and then compensating the drift by removing the code phase from the predicted navigation data bit edge.

The following description discusses a bit synchronization engine implementable for software-based (or hardware-based) GPS receivers. However, it should be understood that the present invention is readily implementable to other GNSS systems such as the GLONASS system of Russia, the GALILEO system of European Union, the BEIDOU/COMPASS system of China and any other similar satellite systems in which a plurality of satellites have known accurate reference frequencies.

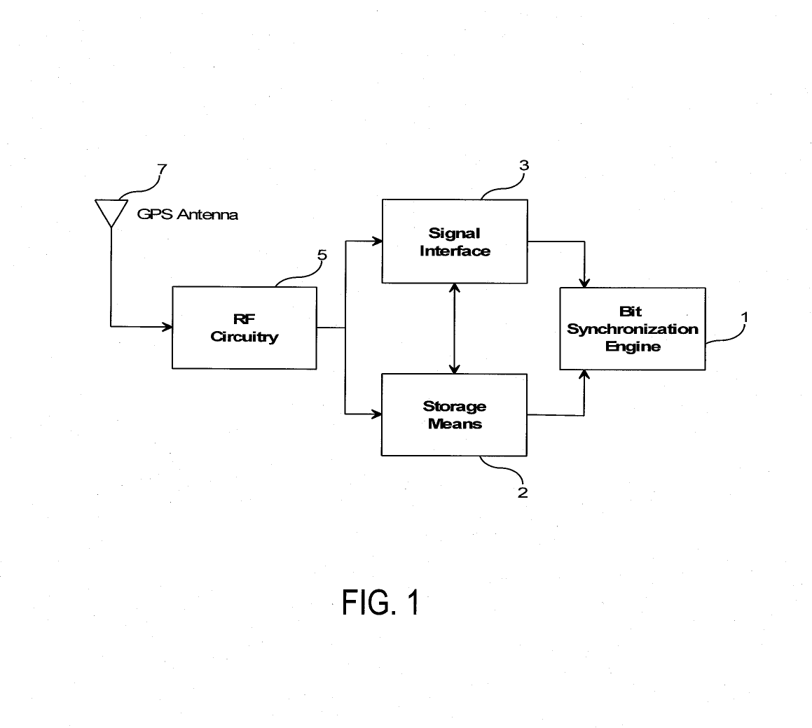

FIG. 1 illustrates a system in accordance with the present invention. The invention may comprise a bit synchronization engine 1 linkable to a signal interface 3 and/or to a storage means 2, which may be further linked to RF circuitry 5 and GPS antenna 7. The RF circuitry may be operable to provide down-converting, signal conditioning/filtering, automatic gain controlling and analog-to-digital converting of the analog GPS satellite signals to I/Q samples. The signal interface 3, which may for example be a USB interface, may transmit I/Q samples to the bit synchronization engine. The bit synchronization engine may receive I/Q samples from the RF circuitry via the signal interface and/or the storage means. I/Q samples may also be passed between the signal interface and the storage means.

The system may also be implemented as a distributed computing system, for example comprising a client device linked by network to a server device wherein the server device may provide processing functionality. If the I/Q samples are processed at the server device, very little bandwidth may be required between the client device and server device as the bit synchronization engine requires very few I/Q samples to predict the navigation data bit edge.

The bit synchronization engine may operate in real time or near real time or may be further linked to a storage means which could, for example, enable post-processing for static, low-dynamic and high-dynamic applications.

The I/Q samples may be obtained from: (a) a tracking loop of any GNSS satellite signal receiver (hardware or software based); (b) a GNSS RFIC; (c) a GNSS RF front-end; (d) direct RF sampling using an analogue-to-digital converter (ADC); or (e) any other means by which to obtain the I/Q samples.

The I/Q samples may also be collected from an RF circuitry directly and divided evenly into 1 ms each for processing. During acquisition, both Code Phase and Doppler Frequency Shift measurements may be obtained with as little as 1 ms I/Q samples. However, if the navigation data bit transition of a satellite signal occurs in the middle of the 1 ms sampled data, acquisition may fail to obtain the correct Code Phase and Doppler Frequency Shift measurements of that satellite signal. By performing navigation data bit synchronization, both Code Phase and Doppler Frequency Shift measurements may be obtained with every 1 ms I/Q samples, thus 1,000 Hz independent raw measurements and PVT solution may be achieved.

The bit synchronization engine detects the navigation data bit transition for each satellite. After the location of the navigation data bit transition for a satellite signal is determined, the navigation data of this satellite signal may be removed, or compensated.

Multiple techniques can be used to detect the navigation data bit transition. The histogram method, which is the most popular method to detect the navigation data bit transition, partitions the 20 ms navigation data bit length into twenty 1 ms C/A code periods. This method detects sign changes between the coherent integration values of the successive C/A code period and records these sign changes by incrementing the count in the bin corresponding to that particular code period. The code offset can be determined from a peak in the histogram that exceeds a pre-specified upper threshold. In the absence of noise, a peak will occur only at the true offset value. However, due to the presence of noise, it is possible that peaks may appear in bins other than the true code offset, thus the histogram method may fail.

The bit synchronization engine may implement a method in accordance with the present invention to detect the navigation data bit transition efficiently and robustly.

The bit synchronization engine may include one or more of (i) a coarse search utility, (ii) a regular search utility, (iii) a fine search utility and (iv) a bit-edge prediction utility.

### Positive & Negative Pair Match Method

A “positive & negative pair match” method may be used to detect the navigation data bit transition.

The “positive & negative pair match” method begins by dividing a data set S containing 2 or more elements of some numerical values, into two complementary but disjoint data sets A and B.

Data set A may comprise elements with relatively small values of data set S, while data set B may comprise relatively large values. After the data sets are divided, data sets A and B may be tested against one or more criteria.

Within a positive & negative pair, one data set may comprise numerical values that indicate an expected event (e.g. positive detection of a navigation data bit transition) is likely to occur. This set may be referred to as the “positive” set. The other set may comprise numerical values that indicate an expected event is unlikely to occur. This set may be referred to as the “negative” set.

For example, S is a data set that has n elements (n≧2) as shown below:

S=[S₁, S₂, . . . Sₙ]

If Sₘₐₓ and Sₘᵢₙ are the maximum and minimum values of the elements in data set S respectively, the average value of Sₘₐₓ and Sₘᵢₙ may be defined as:

S_{avg}=(Sₘₐₓ+Sₘᵢₙ)÷2

Data set S may be divided into data sets A and B using a simple rule, for example, data set A may comprise every value in data set S that is less than S_{avg} while data set B may comprise every value in data set S that is greater than or equal to S_{avg}.

Data sets A and B, therefore, are disjoint since they do not have common elements and they are complementary because their union is set S.

Data sets A and B may further be tested against one or more criteria, for example:
(i) Each set must have at least one element
(ii) The “α” value is greater than a pre-defined threshold “T_{α}” where “α” is defined as the quotient of S_{avg} divided by the standard deviation of either set A or set B depending on whichever has a greater standard deviation.
(iii) The “β” value is greater than a pre-defined threshold “T_{β}” where “β” is defined as the quotient of the mean of either set A or set B, depending on whichever has a greater mean, divided by the mean of the other set that has a smaller mean.
(iv) The “γ” value is greater than a pre-defined threshold “T_{γ}” where “γ” is defined as the mean of the set that has a greater mean.
   The T_{α}, T_{β} and T_{γ} values may be configurable to match the level of the measurement and the system errors. For example, T_{α}, T_{β} and T_{γ} values may be increased if the errors are small or decreased when errors are large. In the case when there is only one element in a set, the standard deviation of this set is deemed to be 0. If the standard deviation of both A and B are 0, the α value is deemed to be positive infinite.

When all criteria are satisfied, the data sets A and B may be referred to as a successful match; otherwise, they may be referred to as a failed match.

### Coarse Search Utility

The coarse search utility may be used to obtain two overlapping data sets of predetermined length which have a navigation data bit transition within their overlapping zone. The following discussion indicates the correlation peak as an indicator for deriving the location of the navigation data peak, however it should be understood that different functions may be implemented based on other indicators including correlation peak, code phase, acquisition margin, or carrier to noise ratio.

The length of the data set is chosen for good overall algorithmic performance by (i) roughly modelling the correlation peak of the data set as a function of the relative coordinate of the data set with respect to the navigation data bit transition, (ii) effectively reducing the noise and (iii) efficiently computing the correlation peaks. The length of the data set was chosen empirically to 10 ms.

For example, if the coarse search utility acquires “m” sets of 10 ms data sets, the total length of the data set is, therefore, m×10 ms. It may be desirable to choose m to avoid unnecessarily high computation load while ensuring a high chance of including a navigation data bit transition in the data sets. Typically, m may be chosen between 3 and 10.

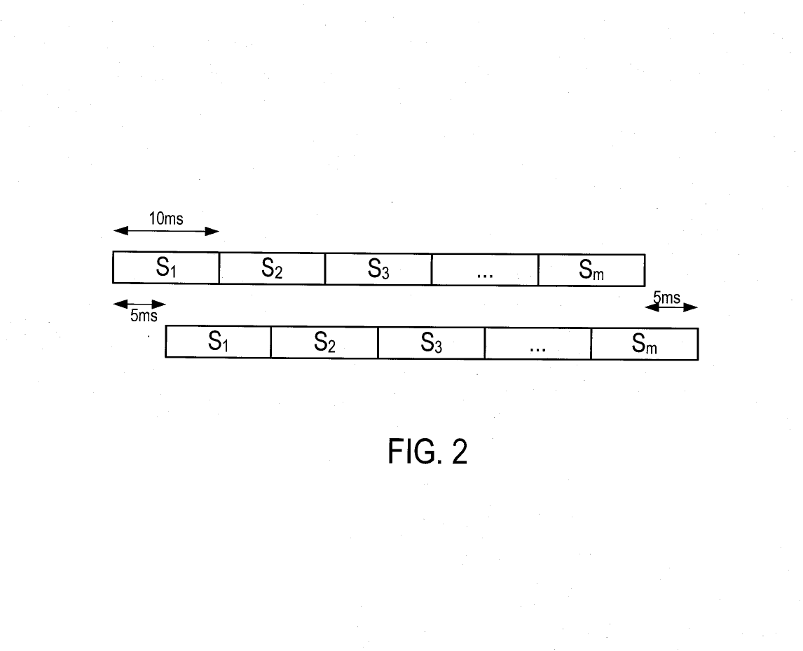

FIG. 2 illustrates two data sets S and S* acquired by the coarse search utility. Data set S may consists of m sets of 10 ms data set and can be represented as:

S=[S₁, S₂, S₃ . . . Sₘ]

By skipping the first 5 ms at the beginning of S and collecting 5 ms more at the end of S, a new set S*, [S₁*, S₂*, S₃* . . . Sₘ*], can be acquired and is represented as:

S*=[S₁*, S₂*, S₃* . . . Sₘ*]

Note that except the first 5 ms of [S₁, S₂, S₃ . . . Sₘ] and the last 5 ms of [S₁*, S₂*, S₃* . . . Sₘ*], [S₁, S₂, S₃ . . . Sₘ] overlaps with [S₁*, S₂*, S₃* . . . Sₘ*].

The coarse search utility may compute the correlation peak of the GPS signal and the locally generated signal of any given satellite signal for every 10 ms data set of their parent sets S and S*.

The correlation peaks of a given GPS signal on data set S may be represented as:

Pₛ=[P₁, P₂, P₃ . . . Pₘ]

Similarly, the correlation peaks of a given GPS signal on data set S* may be represented as:

Pₛ*=[P₁*, P₂*, P₃* . . . Pₘ*]

This new data set Pₛ may be processed using “positive & negative pair match”. T_{α} may be set to an empirical value which is typically greater than 3. If GPS signal is not present, then the α value may not meet the criteria. T_{β} may be set to an empirical value which is typically greater than 1.5. If either the navigation data bit transition is outside of all these 10 ms data sets of S, or the navigation data bit transition is close to the boundaries of these 10 ms data set of S then the β value may not meet the criteria.

Assuming Pₛ has a successful match, data set A and data set B will be produced. Under this situation, the navigation data bit transition is likely to occur in the positive data set A and the navigation data bit transition is not likely to occur in the negative data set B.

The 10 ms data set of data set A that has the minimum correlation peak value may be selected as the first 10 ms data set. However, if either S₁ or Sₘ is selected as the first 10 ms data set, the coarse search utility needs to restart with a larger m value. Assuming Sᵢ is selected as the first 10 ms data set, and Sᵢ is not S₁ or Sₘ, then either Sᵢ₋₁ or Sᵢ of set S*, whichever has a smaller correlation peak value, may be selected as the second 10 ms data set.

These two 10 ms data sets are selected to ensure a navigation data bit transition occurs at the 5 ms overlapped zone of these two sets. These two 10 ms data sets may be passed to the regular search utility to detect and locate the navigation data bit transition, and the coarse search utility may end.

If Pₛ has a failed match because either the α value or the γ value fails to meet the criteria, the coarse search utility may attempt to process for a different satellite signal. If Pₛ has a failed match because of the β value fails to meet the criteria, then data set Pₛ may be processed using the “positive & negative pair match” method similar to data set Pₛ.

Assuming Pₛ has a successful match, data set A and data set B will be produced. The 10 ms data sets of data set A that has the minimum correlation peak value may be selected as the first 10 ms data set. However, if either S₁* or Sₘ* is selected as the first 10 ms data set, the coarse search utility needs to restart with a larger m value. Assuming Sᵢ* is selected as the first 10 ms data set, and Sᵢ* is not S₁* or Sₘ*, then either Sᵢ or Sᵢ₊₁ of set S, whichever has a smaller correlation peak value, may be selected as the second 10 ms data set.

These two 10 ms data sets are selected to ensure a navigation data bit transition occurs at the 5 ms overlapped zone of these two sets. These two 10 ms data sets may be passed to the regular search utility to detect and locate the navigation data bit transition, and the coarse search utility may end.

If Pₛ* has a failed match again, the coarse search utility may attempt to process a different satellite signal. If all satellite signals have been tested and the coarse search utility fails all of them, the coarse search utility may discard the current data sets S and S* then recollect new data sets and restart.

### Regular Search Utility

Base on the results from the coarse search utility, the regular search utility may be used to locate the navigation data bit transition to a typical accuracy of better than 1 ms (or one C/A code period) from its true location.

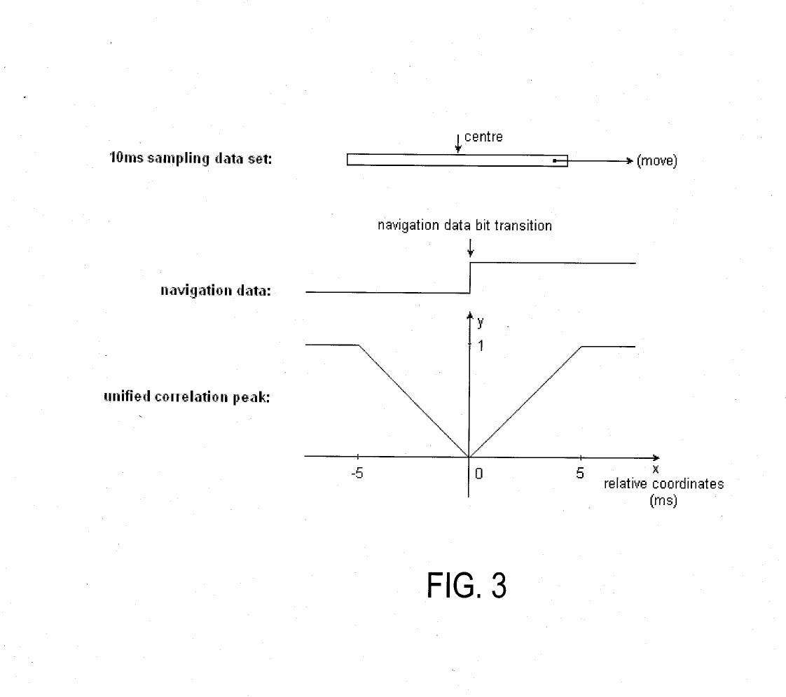

FIG. 3 illustrates the correlation peak of a GPS signal of a 10 ms data set if the effect of noise is not considered. When the centre of the 10 ms data set is moving toward or away from the navigation data bit transition, its relative coordinates with respect to the navigation data bit transition is changing accordingly. The correlation peak of the 10 ms data set is related to the relative coordinates of the centre of the 10 ms data set with respect to the time of the navigation data bit transition. When the navigation data bit transition is located outside of the 10 ms data set, the correlation peak may theoretically be approximated to a constant value which is unified to 1 in FIG. 3. When the navigation data bit transition is located inside the 10 ms data set, the correlation peak may roughly be modelled by a linear function of the relative coordinates of the centre of the 10 ms data set with respect to the navigation data bit transition.

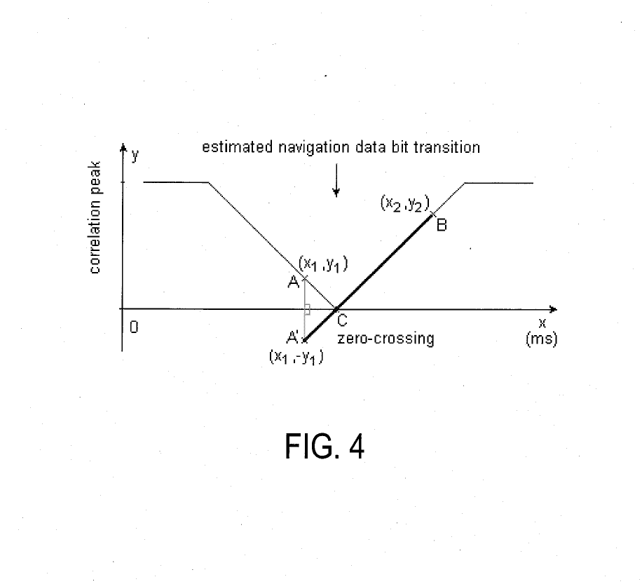

FIG. 4 illustrates how to determine the location of the navigation data bit transition. The x-axis represents the time of the sampled data S and S*, the origin is the beginning of the collected data whereas the y-axis represents the correlation peak value. For example, the centres of the first and the second 10 ms data sets are x₁ and x₂, and their correlation peak values are yᵢ and y₂. These two points can be represented as A(x₁, y₁) and B(x₂, y₂).

The navigation data bit transition occurs at the 5 ms overlapped area of the first and second selected 10 ms data sets. In order to estimate the navigation data bit transition, point A′, or the symmetric point of point A to the x axis, is drawn at (x₁, −y₁) and it is connected to point B at (x₂, y₂). Point C may be obtained as the zero-crossing point of the line connecting A′ and B. The x coordinate of point C is the estimated location of the navigation data bit transition, which can be represented as:

$$\hat{x} = \frac{{x}_{1} * {y}_{2} + {x}_{2} * {y}_{1}}{{y}_{1} + {y}_{2}}$$

where \hat{x} is the estimation of the location of the navigation data bit transition. The next step is to pass the estimate to the fine search utility for refinement.

### Fine Search Utility

Based on the results of the regular search utility, the fine search utility may be used to locate the navigation data bit transition to a typical accuracy of better than 1 μs (or one C/A code chip) from its true location.

Two consecutive 1 ms data sets may be acquired by the fine search utility around \hat{x}. To acquire two consecutive 1 ms data sets for a specified satellite signal, there is at least one 1 ms data set that may not include the navigation data bit transition of this satellite signal. The fine search utility may process these two 1 ms data sets and obtain their Doppler Frequency Shift, Code Phase measurements, and acquisition margins. Among these two 1 ms data sets, the one with the larger acquisition margin may be selected, and its Doppler Frequency Shift, Code Phase measurement and acquisition margin may be stored, while the same of the other 1 ms data set may be discarded.

A much more accurate estimation of the location of the navigation data bit transition may be estimated by:

x_{f}=\hat{x}−φ

where x_{f} is the new estimation of the location of the navigation data bit transition, and φ is the stored Code Phase measurement (in millisecond). Since the navigation data bit transition only occurs at the beginning of a C/A sequence, the fine search utility may remove the Code Phase measurement from \hat{x}.

Three new 1 ms data sets may be acquired by the fine search utility. The first 1 ms data set may be centred at x_{f}. The second 1 ms data set may be centred at a location that is 1 ms before the first 1 ms data set, and the third 1 ms data set may be centred at a location that is 1 ms after the first 1 ms data set.

The fine search utility may process these three 1 ms data sets and obtain their correlation peaks which may be represented as data set [y₁, y₂, y₃]. This new data set [y₁, y₂, y₃] may be processed using “positive & negative pair match”. The fine search utility may set T_{β} to an empirical value which is typically greater than 3. If the navigation data bit transition is not in any of these 1 ms data sets, the β value may not meet the criteria. The T_{β} used by the fine search utility is typically greater than that used by the coarse search utility.

If a successful match is found and there is only one 1 ms data set belonging to set A, the centre of this one 1 ms data set may be deemed the location of the navigation data bit transition obtained by the fine search utility. For example, if this 1 ms data set is the first 1 ms data set, x_{f} may be deemed the location of the navigation data bit transition. If this 1 ms data set is the second 1 ms data set, (x_{f}−1 ms) may be deemed the location of the navigation data bit transition. If this 1 ms data set is the third 1 ms data set, (x_{f}+1 ms) may be deemed the location of the navigation data bit transition. The location of the navigation data bit transition may be passed to the bit-edge prediction utility for predicting the navigation data bit edge, corresponding to the beginning of the next navigation data bit.

For all other cases, the fine search utility may end and the coarse search utility may restart, and the coarse search utility may attempt to process a different satellite signal.

### Bit-Edge Prediction Utility

The bit-edge prediction utility may be used to predict the navigation data bit edge, or the beginning of the next navigation data bit, by skipping forward the current location produced by the fine search utility by a 20 ms offset (length of 1 navigation data bit). The navigation data bit edge can be represented as:

x^{p}=x_{f}+l+e

Where x^{p} is the predicted navigation data bit edge, x_{f} is the estimation of the location of the navigation data bit transition produced by the fine search utility, l is the length of one navigation data bit, and e represents the errors of the predicted navigation data bit edge.

Due to the Doppler Frequency Shift, the receiver clock bias and other error sources, the length of the navigation data bit may be more or less than 20 ms. As such, the predicted navigation data bit edge may drift from its true location, however, the Code Phase measurement may be used to reflect this drift.

Similarly to the fine search utility, the bit-edge prediction utility may acquire two consecutive 1 ms data sets around x^{p}. The bit-edge prediction utility may process these two 1 ms data sets and obtain their Doppler Frequency Shifts, Code Phase measurements and acquisition margins. Among these two 1 ms data sets, the one with the larger acquisition margin may be selected, and its Doppler Frequency Shift, Code Phase measurement and acquisition margin may be stored, while the same of the other 1 ms data set may be discarded.

A new predicted navigation data bit edge may be obtained:

x̅^̅{̅p̅}̅=x^{p}−φ

where x̅^̅{̅p̅}̅ is the latest estimation and φ is the stored Code Phase measurement (in millisecond). The removal of the Code Phase measurement from x^{p} may compensate the drift of the predicted navigation data bit edge.

Once the first predicted navigation data bit edge is determined, it can be used to predict the next navigation data bit edge, and so on. The bit-edge prediction utility may restart and x̅^̅{̅p̅}̅, the predicted navigation data bit edge, may be used to replace x_{f}, the estimation of the location of the navigation data bit transition produced by the fine search utility.

### Extensions: High Sensitivity GNSS Receivers

In order to deal with weak GPS signal problems, traditional GNSS receivers may increase the length of coherent integration period at both acquisition and tracking. However, the presence of the navigation data bit transition limits the maximum coherent integration time to 20 ms which, in some cases, is insufficient for many applications. In order to increase the receiver sensitivity for applications such as indoor navigation, it is desirable to perform coherent integration over a time period that is longer than 20 ms. In accordance with the present invention, the navigation data bit synchronization technique helps increase coherent integration time and thus enabling many new applications.

### Extensions: 1,000 Hz Independent Raw Data and PVT Product

During acquisition, both the Code Phase and Doppler Frequency Shift measurements may be obtained with as little as 1 ms I/Q samples. However, if the navigation data bit transition of a satellite signal occurs in the middle of the 1 ms I/Q samples, acquisition may fail to obtain the correct Code Phase and Doppler Frequency Shift measurements of that satellite signal. The present invention solves this problem by performing navigation data bit synchronization to obtain both the Code Phase and Doppler Frequency Shift measurements every 1 ms I/Q samples. As a result, 1,000 Hz independent raw measurements and PVT solution may be achieved.

Thus, in an aspect, there is provided a system for navigation data bit synchronization for a GNSS receiver, the system comprising: RF circuitry operable to provide analog-to-digital converting of an analog GNSS signal to I/Q samples; a bit synchronization engine having access to a processor and memory and operable to perform navigation data bit synchronization, the bit synchronization engine linkable to a signal interface and a storage means; wherein, the bit synchronization engine receives I/Q samples from the RF circuitry via the signal interface or storage means and is adapted to: detect the location of a navigation data bit transition by utilizing a positive and negative pair match of two complementary but disjoint datasets A and B; test the data set against one or more criteria; and when all criteria are satisfied, determine the data sets A and B to be a match.

In an embodiment, the one or more criteria includes at least one element in each set, and one or more values greater than a pre-defined threshold.

In another embodiment, the bit synchronization engine is operable to: obtain two overlapping data sets of predetermined length which have a navigation data bit transition within their overlapping zone; and utilize one or more indicators for deriving the location of a navigation bit transition.

In another embodiment, the one or more indicators includes a correlation peak, code phase, acquisition margin, or carrier to noise ratio.

In another embodiment, the bit synchronization engine is operable to choose a length of the data set by modelling the correlation peak of a data set as a function of the relative coordinate of the data set with respect to the navigation data bit transition.

In another embodiment, wherein the correlation peak of a data set is related to the relative coordinates of the center of the data set with respect to the time of the navigation data bit, and the bit synchronization engine is operable to: approximate the correlation peak to a constant value unified at 1 if the navigation data bit transition is located outside of the data set; and model the correlation peak by a linear function of the relative coordinates of the center of the data set with respect to the navigation data bit transition if the navigation data bit transition is located inside the dataset.

In another embodiment, the bit synchronization engine is operable to: acquire two consecutive data sets for a specified satellite signal; obtain one or more of their Doppler Frequency Shift, Code Phase measurements and acquisition margins; and compute an accurate bit transition location by removing the Code Phase measurement from the approximate bit transition location.

In another embodiment, the bit synchronization engine is operable to predict the navigation data bit edge by skipping forward the current location produced by the fine search utility be an offset length of one navigation data bit.

In another aspect, there is provided a method for navigation data bit synchronization for a GNSS receiver utilizing a bit synchronization engine having access to a processor and memory engine, the method comprising: converting an analog GNSS signal to digital I/Q samples utilizing RF circuitry; receiving I/Q samples from the RF circuitry via the signal interface or a storage means; detecting the location of a navigation data bit transition by utilizing a positive and negative pair match of two complementary but disjoint datasets A and B; testing the data set against one or more criteria; and determining the data sets A and B to be a match when all criteria are satisfied.

In an embodiment, the method further comprises testing the data set against one or more criteria comprises determining whether there is at least one element in each set, and whether one or more values greater than a pre-defined threshold.

In another embodiment, the method further comprises obtaining two overlapping data sets of predetermined length which have a navigation data bit transition within their overlapping zone; and utilizing one or more indicators for deriving the location of a navigation bit transition.

In another embodiment, the method further comprises utilizing the one or more indicators includes utilizing a correlation peak, code phase, acquisition margin, or carrier to noise ratio.

In another embodiment, the method further comprises choosing a length of the data set by modelling the correlation peak of a data set as a function of the relative coordinate of the data set with respect to the navigation data bit transition.

In another embodiment, the correlation peak of a data set is related to the relative coordinates of the center of the data set with respect to the time of the navigation data bit, and the method further comprises: approximating the correlation peak to a constant value unified at 1 if the navigation data bit transition is located outside of the data set; and modeling the correlation peak by a linear function of the relative coordinates of the center of the data set with respect to the navigation data bit transition if the navigation data bit transition is located inside the dataset.

In another embodiment, the method further comprises: acquiring two consecutive data sets for a specified satellite signal; obtaining one or more of their Doppler Frequency Shift, Code Phase measurements and acquisition margins; and computing an accurate bit transition location by removing the Code Phase measurement from the approximate bit transition location.

In another embodiment, the method further comprises operating the bit synchronization engine to predict the navigation data bit edge by skipping forward the current location produced by the fine search utility be an offset length of one navigation data bit.

In another aspect, there is provided a non-volatile computer readable media storing computer code that when loaded into a system for navigation data bit synchronization for a GNSS receiver adapts the system to perform one of the methods of claims 9 to 16.

While the above description provides illustrative examples of systems and methods in accordance with one or more embodiments, it will be appreciated that other embodiments may be within the scope of the present description and the below claims as interpreted by one of skill in the art.

1. A system for navigation data bit synchronization for a GNSS receiver, the system comprising:
RF circuitry operable to provide analog-to-digital converting of an analog GNSS signal to I/Q samples;
a bit synchronization engine having access to a processor and memory and operable to perform navigation data bit synchronization, the bit synchronization engine linkable to a signal interface and a storage means;
wherein, the bit synchronization engine receives I/Q samples from the RF circuitry via the signal interface or storage means and is adapted to:
detect the location of a navigation data bit transition by utilizing a positive and negative pair match of two complementary but disjoint datasets A and B;
test the data set against one or more criteria; and
when all criteria are satisfied, determine the data sets A and B to be a match.

2. The system of claim 1, wherein the one or more criteria includes at least one element in each set, and one or more values greater than a pre-defined threshold.

3. The system of claim 1, wherein the bit synchronization engine is operable to:
obtain two overlapping data sets of predetermined length which have a navigation data bit transition within their overlapping zone; and
utilize one or more indicators for deriving the location of a navigation bit transition.

4. The system of claim 3, wherein the one or more indicators includes a correlation peak, code phase, acquisition margin, or carrier to noise ratio.

5. The system of claim 4, wherein the bit synchronization engine is operable to choose a length of the data set by modelling the correlation peak of a data set as a function of the relative coordinate of the data set with respect to the navigation data bit transition.

6. The system of claim 5, wherein the correlation peak of a data set is related to the relative coordinates of the center of the data set with respect to the time of the navigation data bit, and the bit synchronization engine is operable to:
approximate the correlation peak to a constant value unified at 1 if the navigation data bit transition is located outside of the data set; and
model the correlation peak by a linear function of the relative coordinates of the center of the data set with respect to the navigation data bit transition if the navigation data bit transition is located inside the dataset.

7. The system of claim 6, wherein the bit synchronization engine is operable to:
acquire two consecutive data sets for a specified satellite signal;
obtain one or more of their Doppler Frequency Shift, Code Phase measurements and acquisition margins; and
compute an accurate bit transition location by removing the Code Phase measurement from the approximate bit transition location.

8. The system of claim 1, wherein the bit synchronization engine is operable to predict the navigation data bit edge by skipping forward the current location produced by the fine search utility be an offset length of one navigation data bit.

9. A method for navigation data bit synchronization for a GNSS receiver utilizing a bit synchronization engine having access to a processor and memory engine, the method comprising:
converting an analog GNSS signal to digital I/Q samples utilizing RF circuitry;
receiving I/Q samples from the RF circuitry via the signal interface or a storage means;
detecting the location of a navigation data bit transition by utilizing a positive and negative pair match of two complementary but disjoint datasets A and B;
testing the data set against one or more criteria; and
determining the data sets A and B to be a match when all criteria are satisfied.

10. The method of claim 9, wherein testing the data set against one or more criteria comprises determining whether there is at least one element in each set, and whether one or more values greater than a pre-defined threshold.

11. The method of claim 9, further comprising:
obtaining two overlapping data sets of predetermined length which have a navigation data bit transition within their overlapping zone; and
utilizing one or more indicators for deriving the location of a navigation bit transition.

12. The method of claim 11, wherein utilizing the one or more indicators includes utilizing a correlation peak, code phase, acquisition margin, or carrier to noise ratio.

13. The method of claim 12, further comprising choosing a length of the data set by modelling the correlation peak of a data set as a function of the relative coordinate of the data set with respect to the navigation data bit transition.

14. The method of claim 13, wherein the correlation peak of a data set is related to the relative coordinates of the center of the data set with respect to the time of the navigation data bit, and the method further comprises:
approximating the correlation peak to a constant value unified at 1 if the navigation data bit transition is located outside of the data set; and
modeling the correlation peak by a linear function of the relative coordinates of the center of the data set with respect to the navigation data bit transition if the navigation data bit transition is located inside the dataset.

15. The method of claim 14, further comprising:
acquiring two consecutive data sets for a specified satellite signal;
obtaining one or more of their Doppler Frequency Shift, Code Phase measurements and acquisition margins; and
computing an accurate bit transition location by removing the Code Phase measurement from the approximate bit transition location.

16. The method of claim 9, further comprising operating the bit synchronization engine to predict the navigation data bit edge by skipping forward the current location produced by the fine search utility be an offset length of one navigation data bit.

17. A non-volatile computer readable media storing computer code that when loaded into a system for navigation data bit synchronization for a GNSS receiver adapts the system to perform one of the methods of claims 9 to 16.
